(19) United States
(12) Patent Application Publication
(10) Pub. No.: US 2013/0244209 A1
(43) Pub. Date: Sep. 19, 2013

(54) PLASTIC IMPLANT ANALOG

(71) Applicants: Albert Zickmann, Chicago, IL (US); Sheldon Lerner, Chicago, IL (US)

(72) Inventors: Albert Zickmann, Chicago, IL (US); Sheldon Lerner, Chicago, IL (US)

(21) Appl. No.: 13/418,412

(22) Filed: Mar. 13, 2012

(51) Int. Cl. A61C 5/10

(52) U.S. Cl. CPC A61C 5/10
USPC 433/218

(57) ABSTRACT

An implant analog for use in dental procedures has a plastic member which has a central bore. A metal insert which has a female thread is located in the central bore. The outer surface of the metal insert has a series of projections which lock the metal insert and the plastic body and prevent relative rotation or axial motion between the metal insert and the plastic member.

### FIELD OF THE INVENTION

The present invention relates generally to the field of dental prosthetics and more particularly, to a plastic implant analog.

### BACKGROUND OF THE INVENTION

In the field of dental implant technology, there is a requirement for an implant analog. The implant analog is a replica of a dental implant which is used in a dental laboratory to fabricate the crown which fits over the dental implant.

Implant analogs or replicas have been difficult and extremely costly to fabricate as the internal aspects of the dental implant must be duplicated very precisely in order to assure an accurate fit of the various components. The accurate fit of components is required in order to assure the proper clinical results.

During the construction of an implant crown, the dentist will take a rubber impression of the patient's mouth with an implant impression coping that is connected to the dental implant which has been inserted in the patient's jaw bone. After the impression has been taken, the impression coping is removed from the patient's dental implant and is connected to an implant analog or replica.

The new assembly of the impression coping and the analog is inserted into the rubber mold and a plaster cast is made. The impression coping is removed once the plaster has set, leaving the implant replica in the exact correct position in the plaster cast of the patient's mouth.

Prior art replicas made of metal are relatively difficult to manufacture and typically cost almost as much to fabricate as the original implant.

### OBJECTS AND SUMMARY OF THE INVENTION

It is an object of the present invention to provide a plastic implant analog which incorporates a threaded insert.

Another object of the present invention is to provide a plastic implant analog which incorporates a relatively high degree of strength in the threaded section.

Yet another object of the present invention is to provide a plastic implant analog which can be manufactured efficiently in volume resulting in a relatively low unit cost.

Other objects and a more complete understanding of the invention will be made clear hereinafter.

In accordance with the present invention, there is provided a plastic implant analog which has a central bore. A metal insert which has a female thread is located in the central bore. The outer surface of the metal insert has a series of projections which lock the metal insert and the plastic body and prevent relative rotation or axial motion between the metal insert and the plastic member.

Additional objects, features and advantages of the invention will be apparent from the following detailed description of the invention when taken in conjunction with the accompanying drawings.

### BRIEF DESCRIPTION OF THE DRAWINGS

FIG. 1 is a cross-sectional view of a plastic implant analog made according to the present invention;

FIG. 2 is a cross-sectional view of the plastic implant analog with the metal insert shown removed for clarity of illustration;

FIG. 3 is a cross-sectional view showing the metal insert;

FIG. 4 is a top view of the metal insert taken along the line 4-4 of FIG. 3;

FIG. 5 is an elevation view of the metal insert taken along the line 5-5 of FIG. 3;

FIG. 6 is an elevation view of an alternative embodiment of the invention;

FIG. 7 shows an alternative embodiment of the invention in which the projecting portions of the insert extend to the peripheral surface of the implant;

FIG. 8 shows another alternative embodiment of the invention in which a female thread is molded into the plastic implant analog;

FIG. 9 shows a cross-sectional view of the metal insert of another alternative embodiment of the invention;

FIG. 10 shows a top view of the metal insert of FIG. 9 taken along the line 10-10 of FIG. 9;

FIG. 11 shows a cross-sectional view of the metal insert of another alternative embodiment of the invention;

FIG. 12 shows a top view of the metal insert of FIG. 11 taken along the line 12-12 of FIG. 11;

FIG. 13 show a cross-sectional view of the metal insert of another alternative embodiment of the invention in which the surface of the metal insert is roughened; and

FIG. 14 shows a cross-sectional view of the metal insert of another alternative embodiment of the invention in which the surface of the metal insert has a recess.

### DETAILED DESCRIPTION OF THE INVENTION

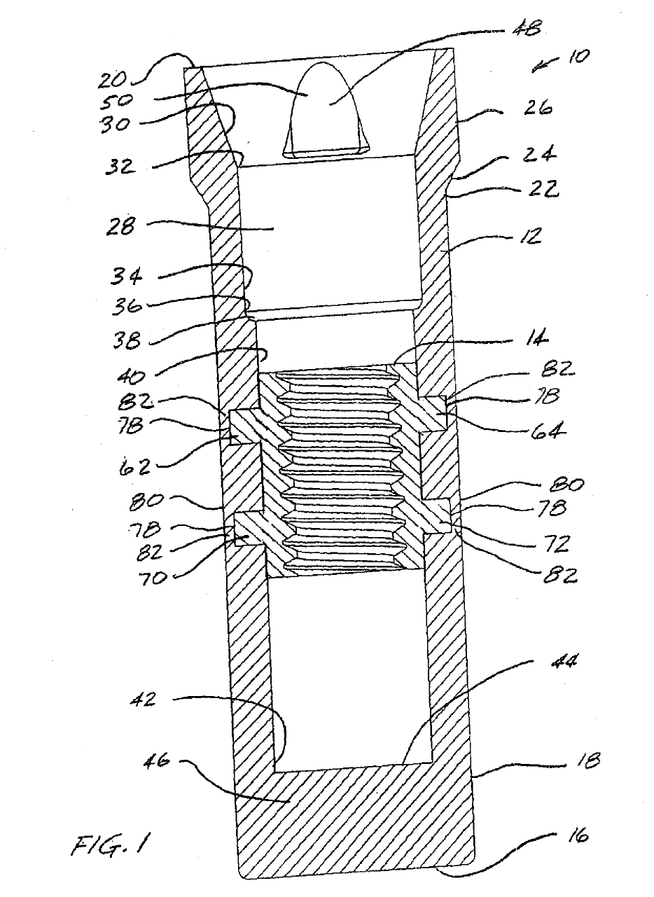

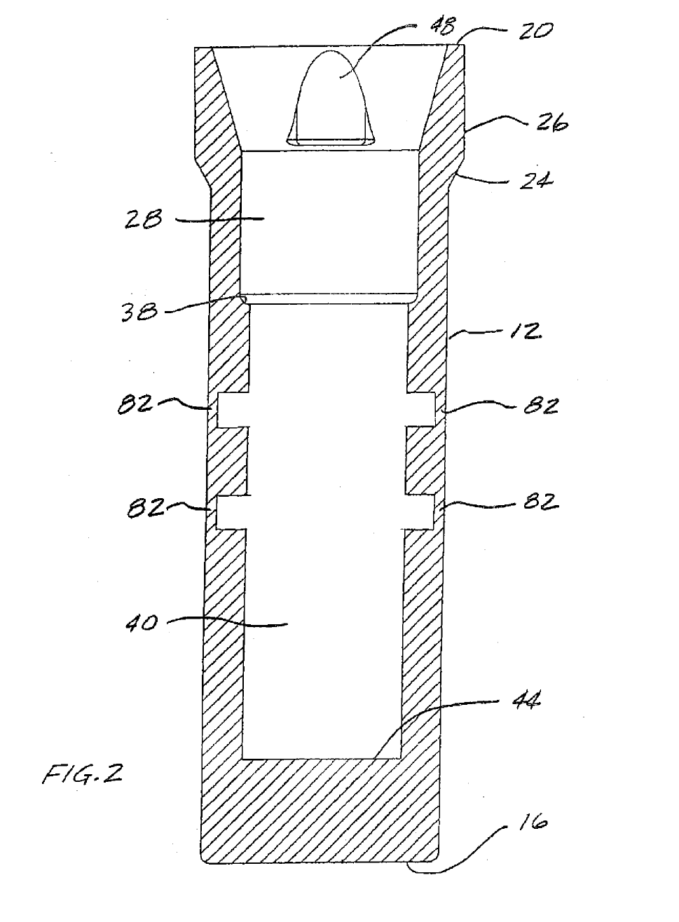

With reference to the drawings, there is shown in FIGS. 1-5 a primary embodiment of a plastic implant analog 10 which includes a plastic body 12 and a metal insert 14.

The plastic body 12 is generally cylindrical in configuration and includes a bottom surface 16, an outer surface 18, and a top surface 20.

The upper end 22 of the outer surface 18 leads to an outwardly tapered portion 24 which in turn leads to an upper portion 26 which is of increased diameter relative to the diameter of the outer surface 18.

A central bore 28 is provided which leads inwardly from the top surface 20. The upper portion 30 of the central bore is inwardly tapered. The bottom 32 of the upper portion 30 leads to a first cylindrical portion 34, the bottom 36 of which leads to a relatively short inwardly curved portion 38. The inwardly curved portion 38 leads to a second cylindrical portion 40 which has an inner diameter slightly smaller than the first cylindrical portion 34. The bottom 42 of the second cylindrical portion 40 leads to the inner surface 44 of the bottom 46 of the plastic body 12. The central bore 28 thus forms a blind cavity.

The upper portion 30 of the central bore 28 includes one or more peripherally disposed cavities 48 which may correspond to and accommodate complementary projections in a tool and may also serve a locating and indexing function. The shape of the peripheral cavity 48 is defined in part by a portion 50 which may be flat or curved.

The second cylindrical portion 40 accommodates the metal insert 14 which forms a key feature of the present invention.

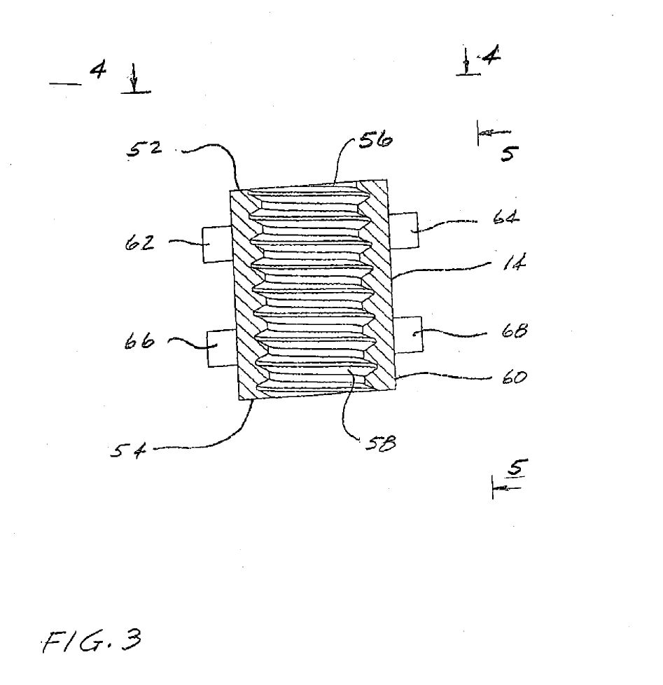

The metal insert 14 is best shown in FIGS. 3-5 in which the metal insert 14 has been shown as being removed from the plastic body 12 for purposes of clarity of illustration.

The metal insert 14 is generally cylindrical in configuration and has a flat top 52 and bottom 54 surfaces.

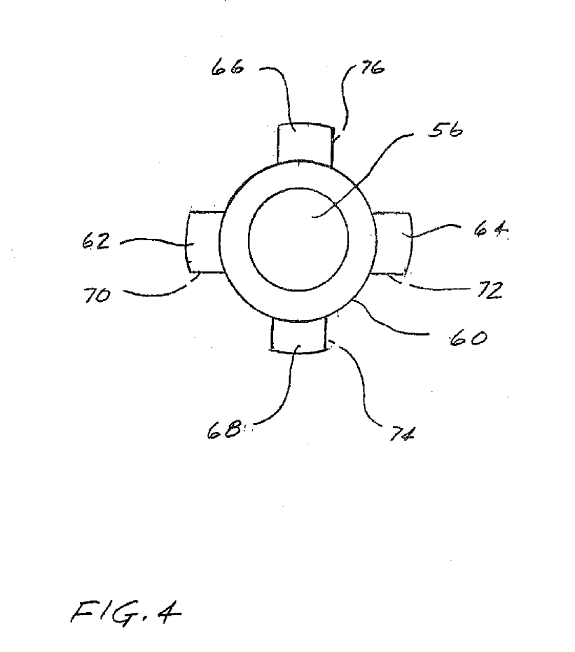

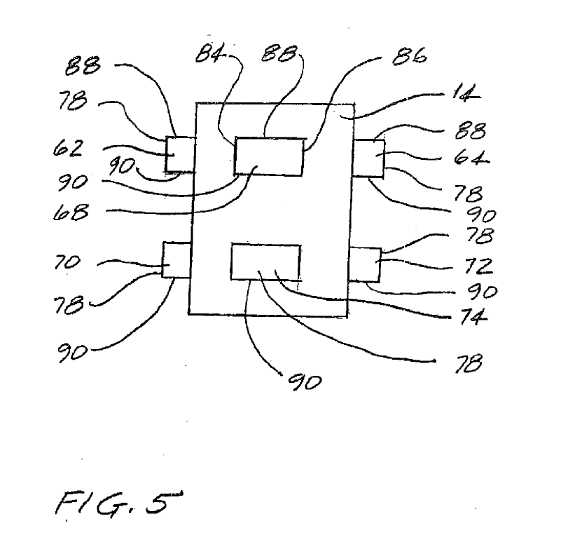

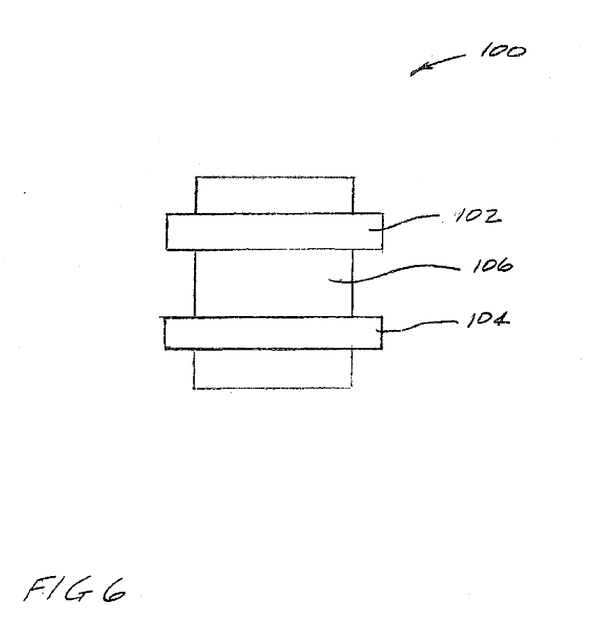

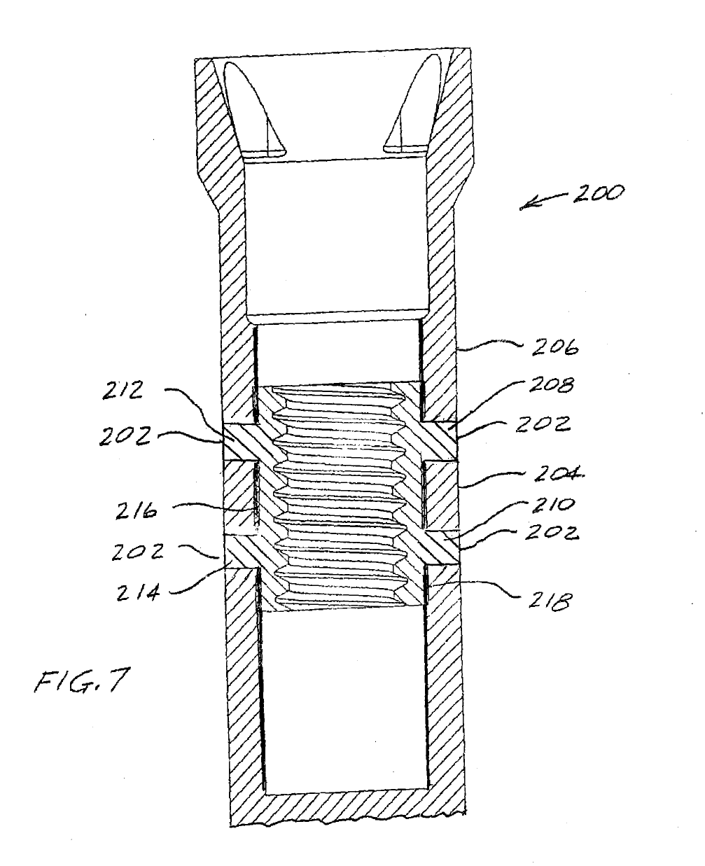

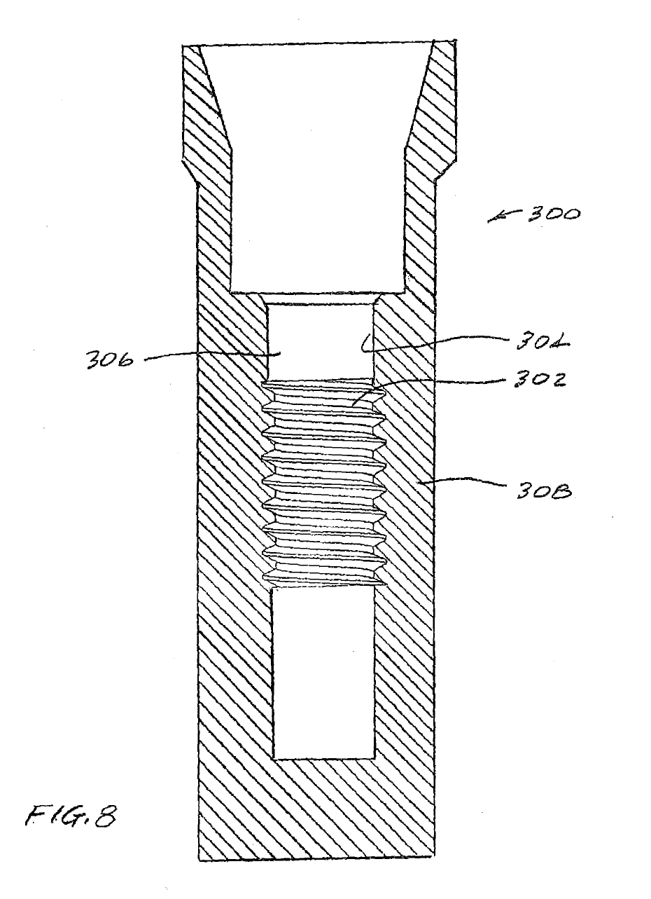

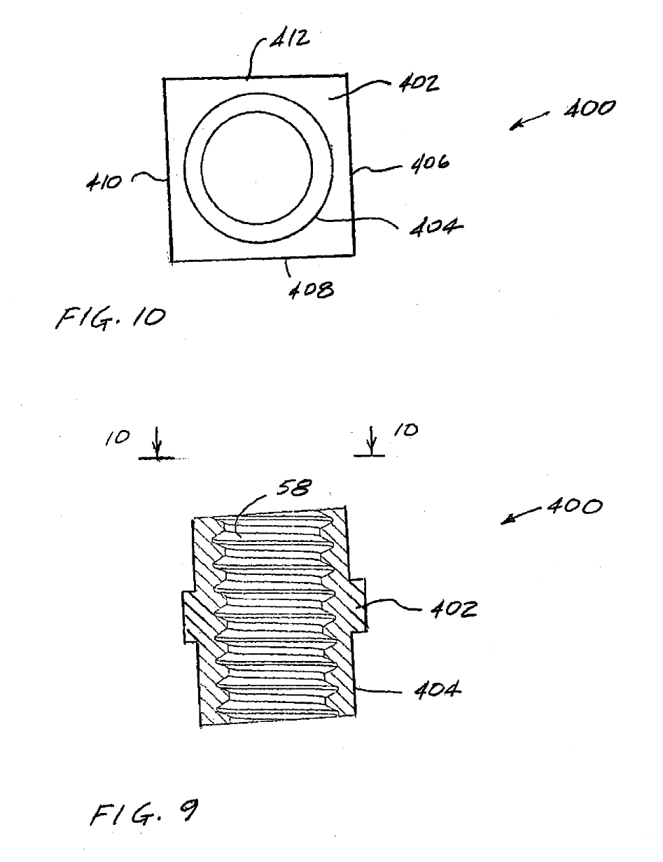

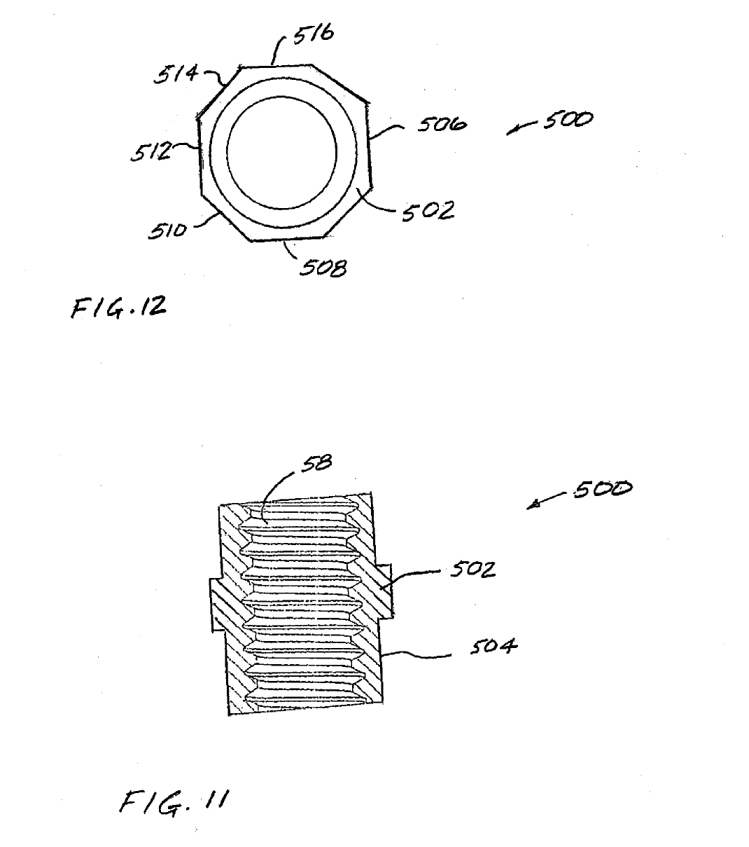

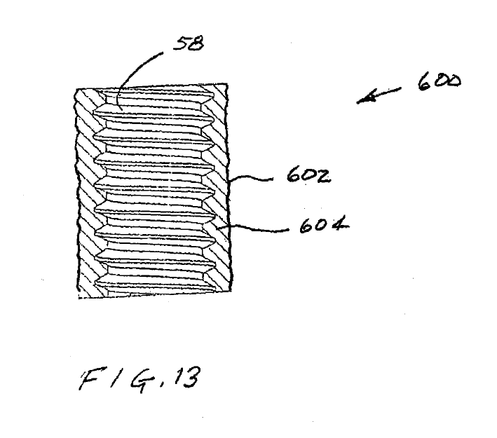

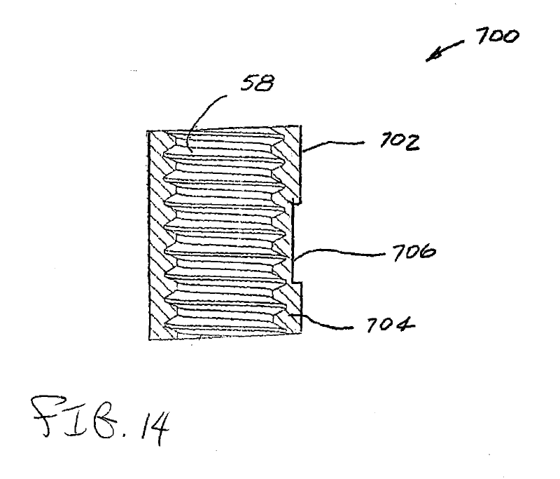

The metal insert 14 has a through bore 56 which has a female thread 58. The outer surface 60 of the metal insert 14 has a plurality of projecting portions 62, 64, 66, 68, 70, 72, 74, 76. As shown in FIGS. 4 and 5, there are two rows each having four projecting portions. As shown in FIG. 4, the projecting portions 70, 72, 74, 76 are below the projecting portions 62, 64, 66, 68, respectively.

The number of projecting portions 62, 64, 66, 68, 70, 72, 74, 76 may be varied within the scope of the invention and may be increased beyond the quantity of eight projecting portions 62, 64, 66, 68, 70, 72, 74, 76 as shown or alternatively, the number of projecting portions 62, 64, 66, 68, 70, 72, 74, 76 may be decreased below the quantity of eight projecting portions shown.

In an alternative embodiment of the invention 100 shown in FIG. 6, the projecting portions previously described may be formed as a pair of continuous peripheral flanges 102, 104 or a band encircling the outer surface 106 resulting in a total quantity of projecting portions 102, 104.

As is shown in FIG. 1, the outer surfaces 78 of the projecting portions 62, 64, 66, 68, 70, 72, 74, 76 extend to a position which is inward relative to the surface portions 80 of the plastic body 12. This results in the plastic body 12 having portions 82 which are outward relative the projecting portions 62, 64, 66, 68, 70, 72, 74, 76.

As is shown in FIG. 5, each of the projecting portions has a pair of side portions 84, 86, a top portion 88, a bottom portion 80, and an outer surface 78.

The incorporation of the projecting portions 62, 64, 66, 68, 70, 72, 74, 76 and 102, 104 increases the surface area of the metal insert 14 which is in direct contact with the plastic body 12. This increase in a surface area decreases the unit stress on the contact area or interface area between the plastic body 12 and the metal insert 14 and prevents relative rotation between the metal insert 14 and the plastic body 12.

In addition, the projecting portions 62, 64, 66, 68, 70, 72, 74, 76 provide a positive mechanical lock between the metal insert 14 and the plastic body 12 which prevents relative rotation or relative axial or longitudinal motion.

In an alternative embodiment 200 which is shown in FIG. 7, the outer surfaces 202 of the projecting portions 208, 210, 212, 214 extend to the surface 204 of the plastic body 206.

In addition to the projecting portions 208, 210, 212, 214 which are generally similar to the projecting portions 62, 64, 66, 70, 72, 74, 76 previously described, FIG. 7 also shows longitudinal projecting portions 216, 218 formed on the metal insert 220.

In another embodiment of the invention 300 shown in FIG. 8, the metal inserts previously described have been eliminated and a threaded portion 302 is molded in the surface 304 of the bore 306 of the plastic body 308.

In another embodiment of the invention 400 shown in FIGS. 9 and 10 the projecting portion 402 of the metal insert 404, which provides an anti-rotation feature, has a generally square configuration having sides 406, 408, 410, 412.

In another embodiment of the invention 500 shown in FIGS. 11 and 12 the projecting portion 502 of the metal insert 504, which provides an anti-rotation feature, has a generally octagonal configuration having sides 506, 508, 510, 512, 514, 516.

It should be understood that in additional alternative embodiments the configuration of the projecting portion may be generally hexagonal or a range of regular and non-regular configurations.

In another embodiment of the invention 600 shown in FIG. 13 the surface 602 of the metal insert 604 is roughened thereby providing an anti-rotation feature. The roughened surface 602 may be irregular as shown in FIG. 13 or it may regular in configuration such as may be produced by knurling.

In another embodiment of the invention 700 shown in FIG. 14 the surface 702 of the metal insert 704 includes at least one recess 706. The recess may be rectangular, square, circular or irregular in configuration. The recess 706 accepts the plastic material previously described and provides an anti-rotation feature.

The process for forming the threaded portion 302 includes the following steps:
forming a cavity in an injection mold corresponding to the outer shape of the plastic member;
forming a mold member having a male thread and portions corresponding to the bore, and forming a fillable mold cavity;
rotationally mounting the mold member in the cavity;
injecting a moldable plastic material into the fillable mold cavity, thereby forming the plastic body and unscrewing the mold member from the plastic body leaving a female thread in the plastic body.

The abutment's engaging features include the portion of the plastic body 12 which is disposed above the metal threaded insert 14 when viewed as in FIG. 1.

The foregoing specific embodiments of the present invention as set forth in the specification herein are for illustrative purposes only. Various deviations and modifications may be made within the spirit and scope of this invention, without departing from a main theme thereof.

What is claimed is:

1. A plastic implant analog comprising:
a plastic body having a central cavity;
a threaded portion formed in said central cavity, for use as a dental implant analog.

2. The plastic implant as claimed in claim 1 wherein said threaded portion comprises:
an injection molded threaded portion.

3. The plastic dental implant as claimed in claim 1 further comprising:
a metal insert disposed within said central cavity with said metal insert having a threaded portion.

4. The plastic dental implant as claimed in claim 3 wherein said metal insert further comprises:
an outer surface, and
at least one projecting portion projecting beyond said outer surface thereby preventing relative motion between said metal insert and said plastic body.

5. The plastic dental implant as claimed in claim 4 wherein said metal insert comprises:
a plurality of projecting portions.

6. The plastic dental implant as claimed in claim 3 wherein said metal insert comprises:
a generally square projecting portion.

7. This plastic dental implant as claimed in claim 3 wherein said metal insert comprises:
a generally hexagonal projecting portion.

8. The plastic dental implant as claimed in claim 3 wherein said plastic body comprises:
a generally cylindrical outer surface and wherein said metal insert comprises;
a generally cylindrical outer surface.

9. The plastic dental implant as claimed in claim 8 wherein said generally cylindrical outer surface of said metal insert further comprises:
at least one recessed portion.

10. The plastic implant analog as claimed in claim 3 wherein said plastic body further comprises:
a first generally cylindrical portion; and
a second generally, cylindrical portion with said first generally cylindrical portion having a diameter somewhat greater than said second cylindrical portion.

11. The plastic implant analog as claimed in claim 3 wherein said metal insert further comprises:
an outer surface and a plurality of projecting portions with said plurality of projecting portions projecting in an outward direction relative to said outer surface.

12. The plastic implant analog as claimed in claim 4 wherein said plurality of projecting portions extends to a diameter somewhat smaller than the diameter of said second cylindrical portion of said plastic body.

13. The plastic implant analog as claimed in claim 4 wherein said plurality of projecting portions extends to a diameter generally equal to the diameter of said second cylindrical portion of said plastic body.

14. The plastic implant analog as claimed in claim 4 wherein said plurality of projecting portions comprises at least one flange portion extending from and encircling said plastic body.

15. The plastic implant analog as claimed in claim 4 wherein said projecting portion comprise a plurality of individual segments each projecting from said plastic body.

16. The plastic implant analog as claimed in claim 1 wherein said threaded portion comprises:
an injection molded thread.
